(19) United States
(12) Patent Application Publication
(10) Pub. No.: US 2026/0342537 A1
(43) Pub. Date: Oct. 29, 2026

(54) SECURE DATA STORAGE USING FRAGMENTED CIPHERTEXT

(71) Applicant: James D. Thackston, St. Petersburg, FL (US)

(72) Inventor: James D. Thackston, St. Petersburg, FL (US)

(21) Appl. No.: 19/715,982

(22) Filed: Jun. 22, 2026

Related U.S. Application Data
(63) Continuation-in-part of application No. 19/025,763, filed on Jan. 16, 2025.
Application No. 19/025,763 is a continuation of application No. 17/591,567, filed on Feb. 2, 2022, now Pat. No. 12,231,533.
(60) Provisional application No. 63/144,833, filed on Feb. 2, 2021.
(60) Provisional application No. 63/827,907, filed on Jun. 21, 2025.

(51) Int. Cl. H04L 9/06; G06F 21/60; H04L 9/08; H04L 9/40

(52) U.S. Cl. CPC H04L 9/0618; G06F 21/602; H04L 9/0822; H04L 63/0478

(57) ABSTRACT

Methods of securely storing and retrieving an electronic data file in which encrypted data and the encryption key are fragmented and distributed across multiple networks are described. An encryption initialization vector may also be stored in a separate network, and the various networks may be monitored by a cross-network AI engine to evaluate retrieval requests and prevent unauthorized retrieval and decryption of the electronic data file.

This application claims priority to U.S. Provisional Patent Application No. 63/827,907, filed Jun. 21, 2025, and entitled “SECURE DATA STORAGE USING FRAGMENTED CIPHERTEXT,” the entire contents of each of which are hereby incorporated by reference for all purposes. This application is also a Continuation in Part of U.S. patent application Ser. No. 19/025,763, filed Jan. 16, 2025, and entitled DATA SECURITY USING FRAGMENTED CIPHERTEXT, which application is a continuation application of U.S. patent application Ser. No. 17/591,567, filed Feb. 2, 2022, and now issued as U.S. Pat. No. 12,231,533 and entitled DATA SECURITY USING FRAGMENTED CIPHERTEXT, which application claims priority to U.S. Provisional Patent Application No. 63/144,833, filed Feb. 2, 2021, and entitled “Quantum-Resistant Data Security Using Fragmented Ciphertext,” the entire contents of each of which are hereby incorporated by reference for all purposes.

### BACKGROUND

The present subject matter relates to the field of cyber security, and more specifically, to protecting electronic data and establishing human identities in cyber space.

The increased dangers of hacking data storage in the age of Artificial Intelligence (AI) stem from AI's dual role as both a powerful enabler of attacks and a high-value, vulnerable target itself. In effect, AI supercharges cyberattacks on data storage. AI tools lower the barrier to sophisticated hacking, making breaches faster, more scalable, automated, and harder to detect. AI allows automated reconnaissance and targeting by rapidly analyzing public data, identifying high-value targets, and crafting personalized phishing or social engineering attacks (e.g., deepfakes or convincing messages). AI can also use advanced malware and exploits via automated malware generation, vulnerability discovery, ransomware adaptation, and evasion of defenses.

AI can also process and analyze exfiltrated data at unprecedented speed to extract insights, train further models, or enable follow-on attacks. What once required skilled human operators can now be done by novices using AI, increasing the volume and impact of attacks on databases and cloud storage.

AI Systems Create Massive New Attack Surfaces and Data Concentrations. Modern AI (especially generative models and LLMs) relies on vast datasets, often including sensitive information, turning them into prime targets. Hackers can use techniques like prompt injection to trick AI systems into revealing private data. Models can unintentionally leak training data or user inputs (e.g., via bugs or poor isolation). Thus, AI models themselves can become targets for theft. Employees pasting sensitive data into AI tools (chatbots, copilots) creates widespread leakage risks. Many organizations have sensitive data flowing into unsanctioned or high-risk AI apps. Attackers can also corrupt training data or extract/reverse-engineer sensitive information from models, undermining integrity and enabling further breaches. This is particularly dangerous for sectors like healthcare, finance, and enterprises holding PII, IP, or regulated data.

AI helps attackers quickly sift through stolen data for valuable assets, de-anonymize users, or launch identity theft/fraud at scale. Proliferation of AI tools often bypasses security controls, poor encryption, and inadequate access management amplify traditional storage risks. Breaches lead to higher costs, fines (e.g., GDPR), reputational damage, and operational disruptions.

Moreover, the cost of cyber-attacks for both governments and private businesses is ever increasing as demonstrated by the recent SolarWinds hack. For private commercial entities, the primary concern is the monetary and reputational cost associated with data theft. For governments, the costs are measured in terms of damage to national security. Both the 2014 Office of Personnel Management breach and the more recent SolarWinds hack perfectly illustrate the national security cost to the United States Government even before the increased threats and vulnerabilities presented by AI became manifest.

### SUMMARY

This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter.

According to first aspects of the disclosure, a method of securely storing and retrieving an electronic data file may include obtaining the electronic data file, generating an encryption key, generating an encryption initialization vector, and encrypting the electronic data file into a ciphertext file based on the encryption key and the encryption initialization vector. Embodiments may include splitting the encryption key into at least a first encryption key fragment and a second encryption key fragment, splitting the ciphertext file into at least a first ciphertext file fragment and a second ciphertext file fragment, and causing the first encryption key fragment and the first ciphertext file fragment to be stored on a first network. The second encryption key fragment and the second ciphertext file fragment may be stored on a second network and the encryption initialization vector may be stored on a third network.

According to further aspects of the disclosure, in response to a retrieval request, the first encryption key fragment and the first ciphertext file fragment may be retrieved from the first network, and/or the second encryption key fragment and the second ciphertext file fragment may be retrieved from the second network. The encryption key may be assembled from the first encryption key fragment and the second encryption key fragment, and the ciphertext file may be assembled from the first ciphertext file fragment and the second ciphertext file fragment. The encryption initialization vector may be retrieved from the third network, and the assembled ciphertext file may be decrypted based on the assembled encryption key and the encryption initialization vector.

In embodiments, each of the first network, the second network, and the third network may have a security protocol that is different than the other networks.

In embodiments, retrieval request data for each of the first network, the second network, and the third network may be analyzed to develop historical retrieval request data models. In embodiments, a retrieval request may be interrupted and/or canceled based on automated analysis performed on transaction logs for each of the first network, the second network, and the third network. In embodiments, the interruption or cancellation of a retrieval request may be based on a comparison of current retrieval request data for at least one of the first network, the second network, and the third network against previously analyzed transaction logs for at least one of the first network, the second network, and the third network. In embodiments, the interruption or cancellation of a retrieval request may be based on a comparison of current retrieval request data for at least two of the first network, the second network, and the third network against previously analyzed transaction logs for at least two of the first network, the second network, and the third network. In embodiments, the interruption or cancellation of a retrieval request may be based on a comparison of current retrieval request data for the first network, the second network, and the third network against previously analyzed transaction logs for the first network, the second network, and the third network.

In embodiments, at least one of assembling the encryption key from the first encryption key fragment and the second encryption key fragment, assembling the ciphertext file from the first ciphertext file fragment and the second ciphertext file fragment, or decrypting the assembled ciphertext file may be based on a comparison of current retrieval request data and the historical retrieval request data models.

In embodiments, the retrieval request data may include response times for retrieving the first encryption key fragment and the first ciphertext file fragment from the first network, and/or retrieving the second encryption key fragment and the second ciphertext file fragment from the second network, and/or retrieving the encryption initialization vector from the third network.

In embodiments, the historical retrieval request data may be analyzed over time to develop independent historical retrieval request data models for each of the first network, the second network, and the third network. In embodiments, each of the historical retrieval request data may be analyzed by a cross-network AI engine.

In embodiments, at least one of assembling the encryption key from the first encryption key fragment and the second encryption key fragment, assembling the ciphertext file from the first ciphertext file fragment and the second ciphertext file fragment, or decrypting the assembled ciphertext file can be halted based on a discrepancy between the current retrieval request data and the historical retrieval request data models.

In embodiments, the electronic data file is an image file.

In embodiments, the first network, the second network, and the third network are hosted by different service providers.

In embodiments, the first network, the second network, and the third network include different security hardware.

According to further aspects of the disclosure, a method of securely retrieving an electronic data file may include one or more of retrieving a first encryption key fragment and a first ciphertext file fragment from a first network, retrieving a second encryption key fragment and a second ciphertext file fragment from a second network, assembling an encryption key from the first encryption key fragment and the second encryption key fragment, assembling a ciphertext file from the first ciphertext file fragment and the second ciphertext file fragment, retrieving an encryption initialization vector from a third network, and decrypting the assembled ciphertext file based on the assembled encryption key and the encryption initialization vector.

In embodiments, each of the first network, the second network, and the third network has a security protocol that is different than the other networks.

In embodiments, retrieval request data for each of the first network, the second network, and the third network is analyzed and/or stored to develop historical retrieval request data models.

In embodiments, at least one of assembling the encryption key from the first encryption key fragment and the second encryption key fragment, assembling the ciphertext file from the first ciphertext file fragment and the second ciphertext file fragment, or decrypting the assembled ciphertext file is based on a comparison of current retrieval request data and the historical retrieval request data models.

In embodiments, the retrieval request data includes response times for retrieving the first encryption key fragment and the first ciphertext file fragment from the first network, and retrieving the second encryption key fragment and the second ciphertext file fragment from the second network, and retrieving the encryption initialization vector from the third network.

In embodiments, the historical retrieval request data is analyzed over time to develop independent historical retrieval request data models for each of the first network, the second network, and the third network.

In embodiments, at least one of assembling the encryption key from the first encryption key fragment and the second encryption key fragment, assembling the ciphertext file from the first ciphertext file fragment and the second ciphertext file fragment, or decrypting the assembled ciphertext file can be halted based on a discrepancy between the current retrieval request data and the historical retrieval request data models.

According to further aspects of the disclosure, a method of securely storing and retrieving an electronic data file may include one or more of obtaining the electronic data file; generating an encryption key; encrypting the electronic data file into a ciphertext file based on the encryption key; splitting the encryption key into at least a first encryption key fragment, a second encryption key fragment, and a third encryption key fragment; splitting the ciphertext file into at least a first ciphertext file fragment and a second ciphertext file fragment; causing the first encryption key fragment and the first ciphertext file fragment to be stored on a first network; causing the second encryption key fragment and the second ciphertext file fragment to be stored on a second network; and/or causing the third encryption key fragment to be stored on a third network.

Embodiments may include, in response to a retrieval request, one or more of retrieving the first encryption key fragment and the first ciphertext file fragment from the first network, retrieving the second encryption key fragment and the second ciphertext file fragment from the second network, retrieving the third encryption key fragment from the third network, assembling the encryption key from the first encryption key fragment, the second encryption key fragment, and the third encryption key fragment, assembling the ciphertext file from the first ciphertext file fragment and the second ciphertext file fragment, and/or decrypting the assembled ciphertext file based on the assembled encryption key.

In embodiments, each of the first network, the second network, and the third network has a security protocol that is different than the other networks.

In embodiments, retrieval request data for each of the first network, the second network, and the third network is analyzed and/or stored to develop historical retrieval request data models.

In embodiments, at least one of assembling the encryption key, assembling the ciphertext file, or decrypting the assembled ciphertext file is based on a comparison of current retrieval request data and the historical retrieval request data models.

In embodiments, the retrieval request data includes response times for retrieving the first encryption key fragment and the first ciphertext file fragment from the first network, and retrieving the second encryption key fragment and the second ciphertext file fragment from the second network, and retrieving the third encryption key fragment from the third network.

In embodiments, the historical retrieval request data is analyzed over time to develop independent historical retrieval request data models for each of the first network, the second network, and the third network.

In embodiments, at least one of assembling the encryption key, assembling the ciphertext file, or decrypting the assembled ciphertext file can be halted based on a discrepancy between the current retrieval request data and the historical retrieval request data models.

According to further aspects of the disclosure, instructions for performing any of the described processes or method may be embodied on computer readable storage media, such instructions being configured to allow various computer systems to perform the described processes and/or methods.

These and other aspects of the invention will now become apparent to those of ordinary skill in the art upon review of the following description of embodiments of the invention in conjunction with the accompanying drawings.

### BRIEF DESCRIPTION OF THE DRAWINGS

So that the manner in which the above-recited features of embodiments can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts aspects of an exemplary secure data storage system according to aspects of the disclosure.

FIG. 2 depicts aspects of exemplary transaction log communications according to aspects of the disclosure.

FIG. 3 depicts aspects of an exemplary process flow for reconstituting encrypted information according to aspects of the disclosure.

FIG. 4 depicts aspects of an exemplary process flow for encrypting and fragmenting information according to aspects of the disclosure.

FIG. 5 depicts aspects of exemplary distributed AI agents and communication paths according to aspects of the disclosure.

It is to be expressly understood that the description and drawings are only for the purpose of illustrating certain embodiments of the invention and are an aid for understanding. They are not intended to be a definition of the limits of the invention.

### DETAILED DESCRIPTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a fragment” is a reference to one or more data fragment and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law.

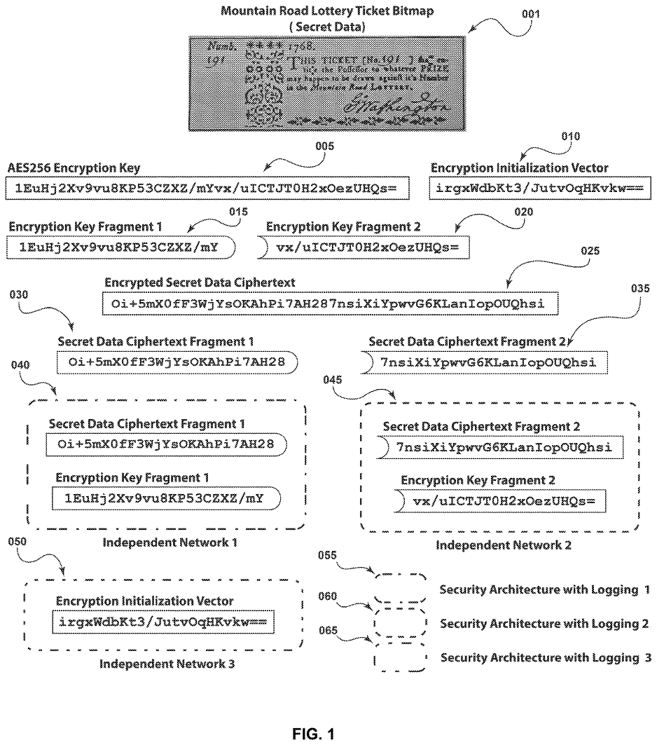

At the top of FIG. 1, exemplary Secret Data 001 (in this case an unencrypted bitmap image) is depicted. This represents original, sensitive content that must be protected. From this point forward, the image is never stored or transmitted in its original form; instead, it is encrypted, fragmented, and distributed to ensure confidentiality and integrity.

Encryption Primitives. Before encryption, two core components are generated. One is an Encryption Key 005 (in this case an AES-256, 256-bit symmetric key, depicted in Base64 as 1EuHj2Xv9vu8KP53CZXZ/mYvx/uICTJT0H2xOezUHQs=). This key is fundamental: without it, decryption of the encrypted data is computationally infeasible.

Second, is an Encryption Initialization Vector (IV) 010. This may be, for example, a 128-bit value (shown as irgxWdbKt 3/JutvOqHKvkw==) that ensures identical plaintexts yield different ciphertexts each time. While the 010 may not be “secret” in the same way as the AES key, it may be stored securely to prevent tampering or replay.

The two elements 005 and 010 may serve as inputs to the AES-256 encryption algorithm. The next step uses these inputs to convert the original bitmap into ciphertext.

Using AES-256 with key 005 and IV 010, the unencrypted bitmap 001 may be transformed into a single blob of ciphertext 025. In FIG. 1, that ciphertext is represented as: Oi+5mX0fF3WjYsOKAhPi7AH287nsiXiYpwvG6KLanIopOUQhsi.

At this stage, the content is scrambled: it is no longer interpretable as an image. Possession of 025 alone does not allow any reconstruction of the Secret Data 001 (e.g. bitmap) without both the encryption key 005 and the IV 010.

Fragmentation of Key and Ciphertext. To reduce risk further, the system splits both the encryption key 005 and the ciphertext 025 into two fragments each: Encryption Key Fragment 1, 015 (1EuHj2Xv9vu8KP53CZXZ/mY, i.e. the first portion of the AES-256 key 005), and Encryption Key Fragment 2, 020 (vx/uICTJT0H2xOezUHQs=, i.e. the remaining portion of the AES-256 key 005).

Ciphertext Fragments include Fragment 1, 030 (Oi+5mX0fF3WjYsOKAhPi7AH28, i.e. the left portion of ciphertext 025), and Fragment 2, 035 (7nsiXiYpwvG6KLanIopOUQhsi, i.e. the right portion of ciphertext 025). Separating both the key and the ciphertext means that no single location holds enough information to decrypt or reconstruct the original data.

Distribution Across Independent Networks. Each fragment is assigned to a distinct network domain (e.g. 040, 045), each with its own security architecture. This “divide and isolate” approach prevents any single compromise from exposing the complete key or complete ciphertext. This unique fragmentation and multi-network distribution scheme enables the implementation of timing verification and other data analysis approaches to ensure easier, more robust anomaly detection. For example, a normal data storage operation securing a sensitive data file will result in 3 sets of audit log entries, one set for each independent network. For the data file storage operation, the 3 sets of audit log entries should occur within a specified number of milliseconds of each other. Artificial intelligence models, trained using audit log data, are used to help monitor audit logs and potentially take actions when an anomalous event is detected. The artificial intelligence model is also trained with data simulating anomalous behavior, enhancing the effectiveness of the artificial intelligence model.

The contents stored on Independent Network 1, 040, may include Ciphertext Fragment 1, 030 (Oi+5mX0fF3WjYsOKAhPi7AH28) and Encryption Key Fragment 1, 015 (1EuHj2Xv9vu8KP53CZXZ/mY). Independent Network 1, or any other network mentioned herein, may include, for example, interconnected computers, servers, storage devices, and networking equipment that operates independently or semi-independently of larger public infrastructures. It can function as its own ecosystem for data storage, processing, communication, and resource sharing. Embodiments may be connected to the internet or other networks through strict gateways, firewalls, and VPNs, allowing organizations to maintain control over security, performance, and data sovereignty. Dedicated resources may include hardware (servers, switches, routers) and software allocated specifically to the network's users or tenants, rather than being shared broadly like in public utilities. Networks can range from a small local setup (a few machines in one building) to large-scale data centers supporting thousands of virtual machines, containers, or applications, and may be managed by the owner/operator or a specialized provider, with full control over configurations, policies, updates, and monitoring. Specific hardware may include any manner of rack-mount servers (1U, 2U, 4U), blade servers, bare-metal dedicated servers, high-performance computing (HPC) nodes, management servers (e.g. for or orchestration, monitoring and/or controlling), Direct-Attached Storage (DAS), Network Attached Storage (NAS) and Storage Area Networks (SAN), enterprise-grade drives, backup appliances, core switches and distribution switches, edge routers/border routers, firewalls and security appliances, load balancers, Content Delivery Network (CDN) edge nodes (if applicable), cabling, Uninterruptible Power Supplies (UPS), Power Distribution Units (PDUs), cooling systems, environmental sensors, etc.

The Security Architecture 1, 055 may include a unique set of perimeter defenses (firewalls, load balancers, etc.) where the hardware and software of network infrastructure appliances differs from the other two networks (e.g. 045 and 050). Comprehensive logging of inbound/outbound traffic, user authentications, configuration changes, and/or other system events detected on network 040 may be stored and/or analyzed in real time. These may be time-synchronized with internal database and blob storage logs. All logging may be time-synchronized with the other independent networks (e.g. 045 and 050).

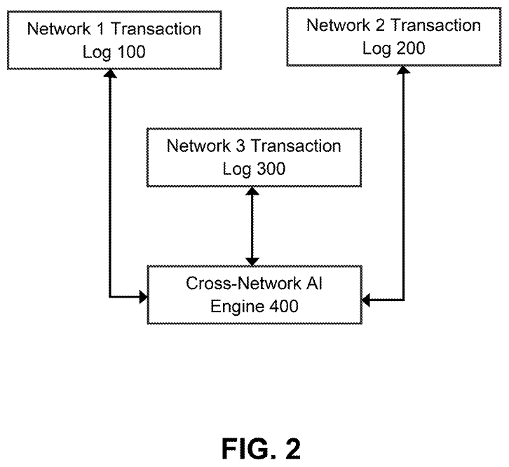

As shown in FIG. 2, sets of audit logs from different networks, e.g. audit log 100 compiled and/or communicated via Security Architecture 055, audit log 200 compiled and/or communicated via Security Architecture 060, and/or audit log 300 compiled and/or communicated via Security Architecture 065, may be aggregated for artificial-intelligence-driven anomaly detection and long-term analysis via one or more Cross-Network AI Engine(s) 400. In embodiments audit logs may be used to train artificial-intelligence model(s), further enabling the detection of anomalies.

Independent Network 2, 045 may be used to store Ciphertext Fragment 2, 035 (7nsiXiYpwvG6KLanIopOUQhsi), Encryption Key Fragment 2, 020 (vx/uICTJT0H2xOezUHQs=), and may include Security Architecture 2, 060. Security Architecture 2, 060 may include a unique set of perimeter defenses (firewalls, load balancers, etc.) where the hardware and software of network infrastructure appliances differs from the other networks (e.g. 040, 050).

Comprehensive logging of inbound/outbound traffic, user authentications, configuration changes, and/or other system events detected on network 045 may be stored and/or analyzed in real time. These may be time-synchronized with internal database and blob storage logs. All logging may be time-synchronized with the other independent networks (e.g. 040 and 050).

As mentioned above, and as shown in FIG. 2, sets of audit logs from different networks, including audit log 200 compiled and/or communicated via Security Architecture 060, may be aggregated for artificial-intelligence-driven anomaly detection and long-term analysis via one or more Cross-Network AI Engine(s) 400. In embodiments such audit logs may be used to train artificial-intelligence model(s), further enabling the detection of anomalies.

Independent Network 3, 050 may be used to store Encryption Initialization Vector 010](irgxWdbKt3/JutvOqHKvkw==), and may include Security Architecture 3, 065. Security Architecture 3, 065 may include its own unique set of perimeter defenses (firewalls, load balancers, etc.) where the hardware and software of network infrastructure appliances differs from the other networks (e.g. 040 and 045).

Comprehensive logging of inbound/outbound traffic, user authentications, configuration changes, and/or other system events detected on network 050 may be stored and/or analyzed in real time. These may be time-synchronized with internal database and blob storage logs. All logging may be time-synchronized with the other independent networks (e.g. 040 and 045).

As mentioned above, and as shown in FIG. 2, sets of audit logs from different networks, including audit log 300 compiled and/or communicated via Security Architecture 065, may be aggregated for artificial-intelligence-driven anomaly detection and long-term analysis via one or more Cross-Network AI Engine(s) 400. In embodiments such audit logs may be used to train artificial-intelligence model(s), further enabling the detection of anomalies.

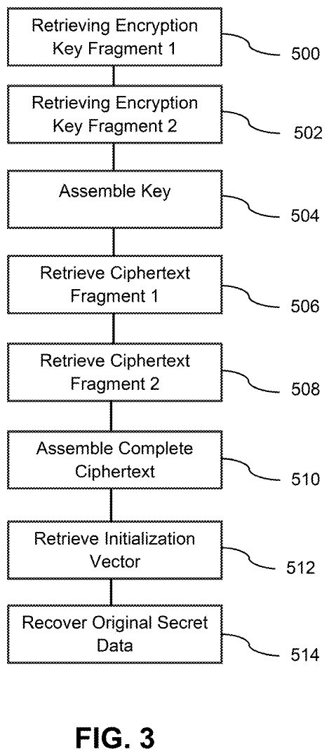

As shown in FIG. 3, to reconstruct the original Secret Data 001, a trusted process may begin with 500 by retrieving Encryption Key Fragment 1, 015 and 502 by retrieving Encryption Key Fragment 2, 020, e.g. from Networks 1, 040, and 2, 045, respectively, and reassemble the complete key 005 at 504.

At 506 the Ciphertext Fragment 1, 030, may be retrieved from Network 1, and at 508 Ciphertext Fragment 2, 035, may be retrieved from Network 2. At 510, the complete encrypted ciphertext 025 may be reassembled.

At 512 the Initialization Vector 010 may be retrieved from Network 3, and at 514 the original Secret Data 001 may be recovered using AES-256 decryption with key 005 and IV 010. As will be appreciated, certain of the foregoing processes may be accomplished substantially simultaneously (e.g. 500 and 502), or in different order (e.g. 506 and 508).

At no point in this workflow is the full key or full ciphertext stored in a single location. This ensures that even if an attacker gains access to one or two fragments, they cannot decrypt the content without colluding across multiple isolated environments. This presents adversaries seeking to steal the secret data with ‘triple entropy’, requiring them to simultaneously breach all three networks.

Distinct Security Architectures and Logging. Each network's security architecture (055, 060, 065) may have the following characteristics:

### Differentiated Perimeter Controls:

Network 1 may use Vendor A hardware and software for network perimeter defenses, Network 2 may use Vendor B hardware and software, and Network 3 may use hardware and software from Vendor C. This deliberate diversity mitigates the risk of a single vulnerability affecting all networks, supporting the ‘triple-entropy’objective.

### Separate Authentication & Access Policies:

Administrators, service accounts, and audit roles are siloed. For example, the team responsible for administering Network 1 is not the same as the team administering Network 2. Likewise, administrator access to Network 3 is restricted by policy. This reduces the risk of insiders accessing both sets of fragmented objects and initialization vectors. In addition to personnel segregation, all computer hardware used to access any of the three network administration accounts is ‘sterile’ meaning that no software not directly related to network administration is permitted and only hardware-based second factors are allowed to be connected. This includes email-clients or any other communication software. Sterile computer equipment is not permitted to leave access-restricted areas.

### Comprehensive Logging for AI Analysis:

Each domain may generate fine-grained logs (traffic flows, file access events, privilege escalations, configuration changes, etc.). As shown in FIG. 2, these logs may feed into AI/ML pipelines to identify anomalous behaviors—early detection of lateral movement or data-exfiltration attempts. Over time, the models become more adept at differentiating normal operational noise from genuine threats.

Geo-and Jurisdictional Segregation: In embodiments, networks can be located in different data centers or cloud regions. This supports compliance with data residency regulations and further increases the logistical difficulty of gathering all fragments.

Security Benefits of This Architecture.

No Single Point of Compromise: An attacker would need to breach at least Networks 1, 2, and 3, in spite of each network's unique security setup. Even if one network is compromised, the fragments stored there (e.g., half of the key and half of the ciphertext) are useless without the complementary fragments split across other domains.

Reduced Blast Radius: Fragmentation ensures that even a successful breach yields only partial information—preventing immediate decryption or data reconstruction.

AI-Driven Threat Detection: Rich logging within each architecture (055, 060, 065) trains AI models to detect subtle patterns—unauthorized key-amalgamation attempts, irregular IV access, or unusual ciphertext retrievals.

Operational Resilience: Each network can be maintained, patched, or audited independently. A vulnerability in Network 2's firewall does not affect Network 1 or 3.

This layered defense strategy aligns with defense-in-depth principles and ensures continuity even under targeted attacks.

### Step-By-Step Flow Summary

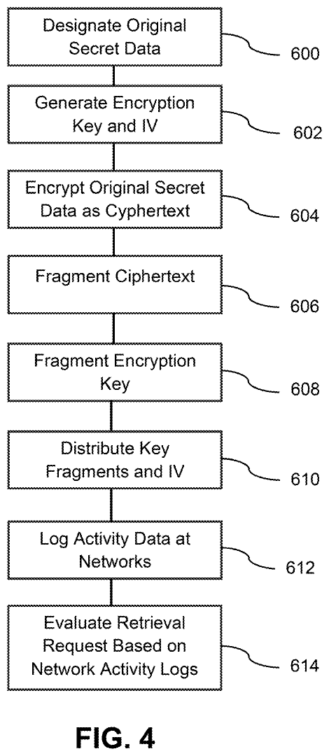

As shown in FIG. 4, an exemplary storage process according to aspects of the disclosure may begin at 600, where original Secret Data 001 (unencrypted bitmap) is designated for high-security storage.

The process may continue at 602, where an Encryption Key 005 and Initialization Vector (IV) 010 are generated.

The process may continue at 604, where Secret Data 001 is encrypted using key 005 and IV 010, producing Ciphertext 025.

The process may continue at 606, where the ciphertext 025 is fragmented, e.g. into Ciphertext Fragment 1, 030, and Ciphertext Fragment 2, 035.

The process may continue at 608, where the encryption key 005 is fragmented, e.g. into Key Fragment 1, 015, and Key Fragment 2, 020.

The process may continue at 610, where key fragments and the IV are distributed across independent networks having different security architectures, e.g. Network 1, 040 holds 030 and 015, protected by Security Architecture 1, 055; Network 2, 045 holds 035 and 020, protected by Security Architecture 2 060; and Network 3, 050: holds 010, protected by Security Architecture 3, 065.

The process may continue at 612, where each independent network's security architecture captures audit, traffic, and configuration logs for AI-based anomaly detection.

The process may continue at 614, where one or more retrieval requests are analyzed and reconstruction of the Secret Data is allowed only by successfully collecting all fragments (015, 020, 030, 035, 010) from their respective networks (any one of which retrievals may be interrupted or canceled by an evaluation of information associated with the retrieval request, e.g. via comparison with multi-network log telemetry) and performing AES-256 decryption.

Artificial Intelligence-Driven Anomaly Detection, Multi-Agent Orchestration, and Extended Correlation

In this section, we explore how the distributed system leverages advanced artificial intelligence (AI), machine learning (ML) models, and autonomous AI agents to analyze security, environmental, and activity logs generated across each independent network's security architecture (055, 060, 065). By standardizing multi-network log telemetry, correlating complex cryptographic transactions, and deploying active defense agents, the system identifies distributed anomalies, behavioral shifts, and subtle adversarial orchestration attempts that evade isolated boundary defenses.

### Log Sources, Feature Engineering, and AI Ingestion Pipeline

The AI subsystem ingests data from localized security architectures, physical administration nodes, and environmental metrics. The schema explicitly captures file metadata, structural file profiles, authenticating identities, and raw HTTP/HTTPS request headers.

### Security Architecture 1 Logs 055

Captures firewall accept/deny actions, identity validation markers, API authentication tokens, metadata records, and process lineage for Independent Network 1 (040). Relevant ingestion features include:

Timestamped HTTPS headers and parameter payloads targeting ingest endpoints (e.g., /api/upload-fragment1,/api/get-fragment1).

User identity verification logs, including hardware-based second-factor identifier tokens tied to administrative service sessions.

Process lineage trees, parent-child application execution chains, and cryptographic hashes of local execution binaries.

### Security Architecture 2 Logs 060.

Records synchronous events for Independent Network 2 (045), detailing ciphertext-fragment storage, key-fragment retrievals (e.g., /api/get-fragment2), and infrastructure state audits. Relevant ingestion features include:

Granular API logs capturing requests seeking retrieval or transformation of objects 035 or 020.

Low-level network flow metadata (source and destination IP blocks, virtual network routing paths, protocol suites, and BGP routing hops).

Process execution state telemetry and local credential handling validation parameters.

### Security Architecture 3 Logs 065

Monitors and logs access bounds for the Encryption Initialization Vector (010), along with administrative cryptographic operations (e.g., rotation cycles, master synchronization calls). Relevant ingestion features include:

HTTPS transit logs documenting transaction handshakes originating from or terminating at Networks 1 or 2.

TLS session metadata, including exact JA3/JA4 client cryptographic fingerprints derived during connection initialization.

Secure enclave attestation measurements, including Platform Configuration Register (PCR) values validating the integrity of the running orchestration software.

### AI Central Processing Pipeline

The unified ingest engine streams all three independent logs through a multi-stage refinement pipeline (FIG. 2).

Data Normalization and Syntactic Parsing: Timestamps, structural event identifiers, and network markers from 055, 060, and 065 are normalized into a unified, high-fidelity schema. Temporal data is adjusted to a high-resolution, universal reference time. Any one of which can be used to compare against real-time retrieval request information.

Advanced Feature Extraction and Embedding: Raw text strings from complete HTTP headers are mapped into semantic vector spaces using Natural Language Processing (NLP) transformer models to classify client signatures. Network parameters, process lineages, and identity metrics are tagged by network domain. Any one of which can be used to compare against real-time retrieval request information.

Baseline Modeling and Multi-Variate Analysis: Historical logs train deep learning autoencoders, isolation forests, and graph-based sequence classifiers to model normal operational choreography. Any one of which can be used to compare against real-time retrieval request information.

Real-Time Correlation Scoring: Active log strings are evaluated continuously against the trained baselines. Cross-network behavioral deviations or unexpected architectural structural changes cause a non-linear elevation in the composite system anomaly score, which can provide a basis for interrupting or canceling a retrieval request.

### Deep Machine Learning Cross-Network Correlation Logic

Authorized system interaction requires structured, multi-network choreography across isolated segments. The core AI models (400) evaluate cross-network relationships using specialized logic rules tailored to detect evasion patterns.

Synchronized Fragment Timing and Network Performance Awareness

Expected Choreography: For example, when an orchestration layer initiates a query inside Independent Network 1 (040) to interact with Ciphertext Fragment 1 (030) or Key Fragment 1 (015), a near-simultaneous transaction must execute within Independent Network 2 (045) for Ciphertext Fragment 2 (035) and Key Fragment 2 (020). This dual-network call must happen within a tight, predefined temporal window ($N$ milliseconds), which can be refined over time using AI, and orchestrated under the same cryptographically verified service token.

Anomaly Evaluation: If the pipeline registers a valid fragment transaction in Security Architecture 055 without a corresponding twin entry in Security Architecture 060 within the designated $N$-millisecond limit, it indicates a structural fragmentation breach. The central sequence models, recognizing the omission of the paired call, automatically elevate the threat index. To insulate this logic from benign system variations, the model dynamically scales the temporal parameter $N$ based on real-time network latency, TCP Round-Trip Time (RTT), and system jitter logs.

### Natural Language Processing (NLP) for HTTP Header Signature Verification

Expected Choreography: Automated processes manipulating fragments output precise HTTP header ordering, casing, character spacing, and parameter structural bounds peculiar to the system's core software libraries. Detection of such anomalies can be enhanced using AI log analysis, and can be used to interrupt or cancel a retrieval request.

Anomaly Evaluation: Deep learning transformer models evaluate complete inbound HTTP headers in real-time. If an API request matches a legitimate administrative credential but uses an anomalous header structure—such as an out-of-order parameter sequence or an artifact characteristic of manual exploitation tools (e.g., unique cURL or Postman header padding)—the NLP model isolates the vector as a client spoofing anomaly, even if the user-agent text matches expected profiles and can be used to interrupt or cancel a retrieval request.

### Enforced Structural IP Constraints and BGP Path Verification

Expected Choreography: Inbound connection paths into the perimeter boundaries of Network 1 (040) and Network 2 (045) are explicitly restricted to the designated virtual IP block allocations of Independent Network 3 (050).

Anomaly Evaluation: Any ingress traffic logged in 055 or 060 that originates outside Network 3's virtual IP block registers as an structural perimeter policy failure. To detect advanced network spoofing threats, the correlation engine matches the reported source IP against low-level BGP routing hop paths and geolocation triangulation logs. If a packet claims a valid Network 3 IP address but arrives over an invalid network transit path, the mismatch triggers an automatic warning, and can be used to interrupt or cancel a retrieval request.

Graph Neural Networks (GNNs) for Operational Topology Tracking

Expected Choreography: Valid data reconstruction protocols follow an inflexible sequence: dual-fragment retrieval from Networks 1 and 2, verification of key fragment recombination within an isolated execution boundary, and a final sequential request to the Initialization Vector (010) in Network 3.

Anomaly Evaluation: The system models multi-network workflows as directed graphs, where independent networks are nodes and transactions are directed edges. A Graph Neural Network (GNN) continuously parses this graph topology. If an Initialization Vector request is logged in Security Architecture 065 that lacks structural precedence links to the necessary fragment calls in Security Architecture 055 and Security Architecture 060, the GNN identifies the topological violation instantly, isolating the out-of-sequence IV access as a severe protocol compromise, and can be used to interrupt or cancel a retrieval request.

### Behavioral Identity Profiling and Process Lineage Analysis

Expected Choreography: Valid service identities run from highly specific, verified binary files inside the network, operating under strict time schedules (e.g., daily archival execution sequences at 02:00 AM UTC).

Anomaly Evaluation: Clustering models create behavioral profiles for every administrative service account and physical terminal. If an account initializes an endpoint transaction outside its historical temporal bounds, or if the request is generated by an unmapped parent process ID or an execution binary whose cryptographic hash does not match production baselines, the sequence is flagged as a compromised credential anomaly, and can be used to interrupt or cancel a retrieval request.

### Autonomous Multi-Agent Defense Architecture and Response Workflow

To transition from passive tracking to active, resilient defense, the architecture implements an autonomous multi-agent mesh network that operates directly within the system's isolated domains.

### Local Sentry Agents

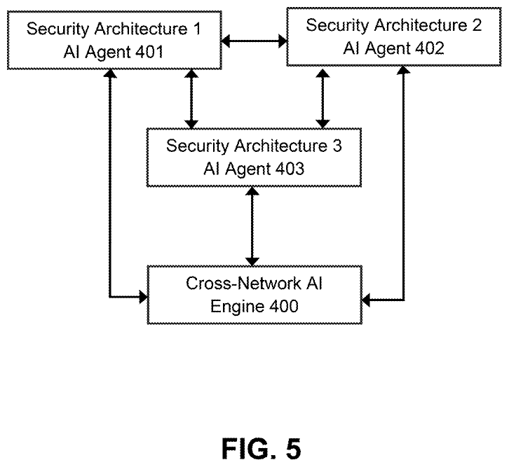

As shown in FIG. 5, lightweight, highly isolated AI agents 401, 402 and/or 403 may be deployed directly within the secure perimeter boundaries of Security Architectures 1, 2, and 3 (055, 060, 065). Operating locally, these Sentry Agents continually monitor local log streams. If a high-confidence, single-domain threat is encountered—such as an invalid local process hash execution or an explicit firewall rule exception—the Sentry Agent may initiate local micro-containment actions instantly (e.g., rolling back access credentials or isolating local network sockets) without waiting for central processing confirmation. AI agents 401, 402 and/or 403 may also communicate such information to AI Engine 400, e.g. for further analysis or distribution to other AI agents. AI agents 401, 402 and/or 403 may also receive information from AI Engine 400, e.g. to enhance the relevant AI learning and/or monitoring of the agents.

### Collaborative Cross-Network Triage Agents

When a multi-domain transaction pattern fails cross-network validation rules—such as a single-sided fragment query that violates the synchronized timing window—the local Sentry Agent initializes a localized “Triage Agent.” As shown in FIG. 5, this specialized, ephemeral agent may communicate over secure backchannels with Sentry Agents in the sister domains using encrypted tokens. The Triage Agent may autonomously query the peer environments to perform real-time verification (e.g., validating if the corresponding network segment experienced documented hardware latency or if the missing transaction was non-existent). This autonomous cross-verification minimizes false alerts caused by infrastructure fluctuations and automates the aggregation of cross-network evidence.

### Active Deception and Honeypot Agents

If the central AI engine (400) or the localized Sentry Agents (401-403) identify an active, targeted data collection attempt, the system may deploy “Honeypot Agents.” These agents analyze the attacker's unique exploit characteristics (mined from raw HTTP headers, TLS JA3/JA4 markers, and source routing profiles). The Deception Agent dynamically generates an isolated, fake network workspace that clones the targeted endpoint. The attacker's session is silently routed into this dynamic honey-environment, where fake fragment artifacts are supplied to contain the threat, map adversarial tactics, and track intent without endangering the authentic secret data (001).

### Centralized Incident Generation and Forensic Compilation

When a multi-agent or model anomaly score breaks past configured security limits, the system outputs a unified system event to the master Security Incident and Event Management (SIEM) boundary.

Standardized Alert Telemetry: “CRITICAL_ALERT: Unmatched fragment request sequence detected. Independent Network 1 logged an authorized endpoint call to/api/get-fragment1 at 2026-06-01 22:15:12.345 UTC. Security Architecture 2 reports no matching synchronized twin call within the calculated latency limit of 420 ms. Connecting client JA4 fingerprint indicates an unmapped environment mismatch. Source network routing path deviates from Network 3 allocations. Enclave PCR validation checks failed. Micro-containment active; forensic analysis initialized.”

Automated Incident Compilation: The Triage Agents compile all relevant logs from Security Architectures 055, 060, and 065 within a precise temporal window ($\pm60$ seconds) into a singular forensic telemetry report. This bundle presents investigators with a comprehensive cross-domain timeline of API metadata, process hashes, network hops, and cryptographic states to accelerate remediation validation.

### Reinforcement Learning and Model Adaptation

Following an incident investigation, the forensic telemetry bundle is re-ingested into an offline training pipeline. If the trigger is validated as a benign environment variation (e.g., unexpected network routing shifts during primary telecom failures), the baseline models adjust their internal parameter weights to eliminate recurring false alerts. If confirmed as a hostile attack, the model hardens its classification boundaries around the discovered adversarial features, process lineages, and client fingerprints to ensure long-term defensive evolution.

### Security Advantages of Advanced AI Telemetry

By integrating machine learning models and multi-agent orchestration directly into the interdependencies of the fragmented data storage architecture, the system achieves the following structural defenses:

Early Interdiction of Coordinated Compromises: An adversary cannot decrypt data without harvesting multiple keys and fragments across isolated silos. The AI models detect the earliest stages of a distributed attack by identifying microscopic timing mismatches, out-of-sequence graph topologies, or atypical HTTP header structures, triggering defensive isolation before an attacker can assemble a viable payload.

Reduction of Operational Alert Fatigue: Rather than generating individual alerts on isolated, ambiguous log entries, the central correlation system evaluates multi-network evidence. Security analyst escalation occurs only when cross-network anomaly signatures emerge, minimizing operational noise and concentrating defensive focus onto verified, systemic threats.

Adaptive Threat Posture Integration: The continuous model training loop integrates forensic data from every security event back into the core algorithms. This ensures that the system's defenses evolve automatically alongside changing adversarial tactics and custom exploit methodologies, maintaining a proactive protective posture.

Unified Architectural Visibility: Although Networks 1, 2, and 3 are physically and administrative siloed to preserve the triple-entropy model, the AI multi-agent layer virtually maps their operations into a coherent, real-time security model. This macro-level correlation is indispensable for neutralizing advanced persistent threats (APTs) that rely on slow, distributed movements across decoupled network environments to bypass standard localized perimeters.

By embedding AI-driven anomaly detection around the interdependencies of key-fragment retrieval, ciphertext access, and IV requests—as captured in Security Architectures 055, 060, and 065—the system delivers a far more proactive and precise defense. Any deviation from the expected multi-network choreography immediately triggers alerts, ensuring that even sophisticated attackers cannot quietly harvest fragments without triggering a high-confidence—cross-network alarm.

This design ensures that the original bitmap (Secret Data 001) never exists unencrypted outside of controlled, ephemeral memory. By generating a strong AES-256 key (005) and IV (010), then fragmenting both key and ciphertext (015, 020, 030, 035) and distributing them across three segregated network domains (040, 045, 050), the system eliminates any single point of failure. Unique security architectures (055, 060, 065) reinforce isolation, and comprehensive logging provides data for AI-driven threat detection and continuous improvement.

In summary, the architecture transforms secret data into a set of distributed fragments that must be reassembled across multiple, independently secured environments before decryption is possible—thereby delivering a robust, defense-in-depth approach to data protection. It should be noted that, although the network architecture, fragmentations and distributions have been described in the context of three networks for ease of understanding, the embodiments are not limited strictly to three networks, and may perform, for example, additional fragmentation and distributions across any number of networks.

Any feature of any embodiment discussed herein may be combined with any feature of any other embodiment discussed herein in some examples of implementation, unless otherwise specified.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

While the foregoing is directed to embodiments of the present invention, other and further embodiments of the invention may be devised without departing from the basic scope thereof, and the scope thereof is determined by the claims that follow.

What is claimed:

1. A method of securely storing and retrieving an electronic data file:
obtaining the electronic data file;
generating an encryption key;
generating an encryption initialization vector;
encrypting the electronic data file into a ciphertext file based on the encryption key and the encryption initialization vector;
splitting the encryption key into at least a first encryption key fragment and a second encryption key fragment;
splitting the ciphertext file into at least a first ciphertext file fragment and a second ciphertext file fragment;
causing the first encryption key fragment and the first ciphertext file fragment to be stored on a first network;
causing the second encryption key fragment and the second ciphertext file fragment to be stored on a second network;
causing the encryption initialization vector to be stored on a third network; and
in response to a retrieval request;
retrieving the first encryption key fragment and the first ciphertext file fragment from the first network,
retrieving the second encryption key fragment and the second ciphertext file fragment from the second network,
assembling the encryption key from the first encryption key fragment and the second encryption key fragment,
assembling the ciphertext file from the first ciphertext file fragment and the second ciphertext file fragment,
retrieving the encryption initialization vector from the third network, and
decrypting the assembled ciphertext file based on the assembled encryption key and the encryption initialization vector;
wherein, each of the first network, the second network, and the third network has a security protocol that is different than the other networks;
wherein, retrieval request data for each of the first network, the second network, and the third network is analyzed to develop historical retrieval request data models; and
wherein, at least one of assembling the encryption key from the first encryption key fragment and the second encryption key fragment, assembling the ciphertext file from the first ciphertext file fragment and the second ciphertext file fragment, or decrypting the assembled ciphertext file is based on a comparison of current retrieval request data and the historical retrieval request data models.

2. The method of claim 1, wherein the retrieval request data includes response times for retrieving the first encryption key fragment and the first ciphertext file fragment from the first network, and retrieving the second encryption key fragment and the second ciphertext file fragment from the second network, and retrieving the encryption initialization vector from the third network.

3. The method of claim 2, wherein the historical retrieval request data is analyzed over time to develop independent historical retrieval request data models for each of the first network, the second network, and the third network.

4. The method of claim 3, wherein at least one of assembling the encryption key from the first encryption key fragment and the second encryption key fragment, assembling the ciphertext file from the first ciphertext file fragment and the second ciphertext file fragment, or decrypting the assembled ciphertext file can be halted based on a discrepancy between the current retrieval request data and the historical retrieval request data models.

5. The method of claim 1, wherein the electronic data file is an image file.

6. The method of claim 1, wherein the first network, the second network, and the third network are hosted by different service providers.

7. The method of claim 1, wherein the first network, the second network, and the third network include different security hardware.

8. A method of securely retrieving an electronic data file:
retrieving a first encryption key fragment and a first ciphertext file fragment from a first network,
retrieving a second encryption key fragment and a second ciphertext file fragment from a second network,
assembling an encryption key from the first encryption key fragment and the second encryption key fragment,
assembling a ciphertext file from the first ciphertext file fragment and the second ciphertext file fragment,
retrieving an encryption initialization vector from a third network, and
decrypting the assembled ciphertext file based on the assembled encryption key and the encryption initialization vector;
wherein, each of the first network, the second network, and the third network has a security protocol that is different than the other networks;
wherein, retrieval request data for each of the first network, the second network, and the third network is analyzed and/or stored to develop historical retrieval request data models; and
wherein, at least one of assembling the encryption key from the first encryption key fragment and the second encryption key fragment, assembling the ciphertext file from the first ciphertext file fragment and the second ciphertext file fragment, or decrypting the assembled ciphertext file is based on a comparison of current retrieval request data and the historical retrieval request data models.

9. The method of claim 8, wherein the retrieval request data includes response times for retrieving the first encryption key fragment and the first ciphertext file fragment from the first network, and retrieving the second encryption key fragment and the second ciphertext file fragment from the second network, and retrieving the encryption initialization vector from the third network.

10. The method of claim 9, wherein the historical retrieval request data is analyzed over time to develop independent historical retrieval request data models for each of the first network, the second network, and the third network.

11. The method of claim 10, wherein at least one of assembling the encryption key from the first encryption key fragment and the second encryption key fragment, assembling the ciphertext file from the first ciphertext file fragment and the second ciphertext file fragment, or decrypting the assembled ciphertext file can be halted based on a discrepancy between the current retrieval request data and the historical retrieval request data models.

12. The method of claim 8, wherein the electronic data file is an image file.

13. The method of claim 8, wherein the first network, the second network, and the third network are hosted by different service providers.

14. The method of claim 8, wherein the first network, the second network, and the third network include different security hardware.

15. A method of securely storing and retrieving an electronic data file:
obtaining the electronic data file;
generating an encryption key;
encrypting the electronic data file into a ciphertext file based on the encryption key;
splitting the encryption key into at least a first encryption key fragment, a second encryption key fragment, and a third encryption key fragment;
splitting the ciphertext file into at least a first ciphertext file fragment and a second ciphertext file fragment;
causing the first encryption key fragment and the first ciphertext file fragment to be stored on a first network;
causing the second encryption key fragment and the second ciphertext file fragment to be stored on a second network;
causing the third encryption key fragment to be stored on a third network; and
in response to a retrieval request;
retrieving the first encryption key fragment and the first ciphertext file fragment from the first network,
retrieving the second encryption key fragment and the second ciphertext file fragment from the second network,
retrieving the third encryption key fragment from the third network,
assembling the encryption key from the first encryption key fragment, the second encryption key fragment, and the third encryption key fragment,
assembling the ciphertext file from the first ciphertext file fragment and the second ciphertext file fragment, and
decrypting the assembled ciphertext file based on the assembled encryption key;
wherein, each of the first network, the second network, and the third network has a security protocol that is different than the other networks;
wherein, retrieval request data for each of the first network, the second network, and the third network is analyzed and/or stored to develop historical retrieval request data models; and
wherein, at least one of assembling the encryption key, assembling the ciphertext file, or decrypting the assembled ciphertext file is based on a comparison of current retrieval request data and the historical retrieval request data models.

16. The method of claim 15, wherein the retrieval request data includes response times for retrieving the first encryption key fragment and the first ciphertext file fragment from the first network, and retrieving the second encryption key fragment and the second ciphertext file fragment from the second network, and retrieving the third encryption key fragment from the third network.

17. The method of claim 16, wherein the historical retrieval request data is analyzed over time to develop independent historical retrieval request data models for each of the first network, the second network, and the third network.

18. The method of claim 17, wherein at least one of assembling the encryption key, assembling the ciphertext file, or decrypting the assembled ciphertext file can be halted based on a discrepancy between the current retrieval request data and the historical retrieval request data models.

19. The method of claim 15, wherein the electronic data file is an image file.

20. The method of claim 15, wherein the first network, the second network, and the third network are hosted by different service providers.
